(19) United States
(12) Patent Application Publication
(10) Pub. No.: US 2016/0002930 A1
(43) Pub. Date: Jan. 7, 2016

(54) PROTECTIVE COVERINGS, SYSTEMS AND METHODS OF APPLICATION

(71) Applicant: Michael Sparks Sylvester, II, Falmouth, ME (US)

(72) Inventor: Michael Sparks Sylvester, II, Falmouth, ME (US)

(21) Appl. No.: 14/749,302

(22) Filed: Jun. 24, 2015

Related U.S. Application Data
(60) Provisional application No. 62/020,791, filed on Jul. 3, 2014.

(51) Int. Cl. E04D 5/10; B32B 37/12; E04D 5/14; B32B 7/12

(52) U.S. Cl. CPC E04D 5/10; B32B 7/12; B32B 37/12; E04D 5/148; B32B 2307/54; B32B 2307/7265; B32B 2307/714; B32B 2307/71; B32B 2419/06

(57) ABSTRACT

The invention features protective coatings and systems for a substrate, particularly a roof, and methods for their application. In one aspect, the invention features a membrane which includes a support layer interposed between a first layer and a second layer. At least one and preferably both of the first and the second layers include a silicon component. At least the second layer has a resistance to water, oxidation, and ultraviolet degradation.

### STATEMENT REGARDING FEDERALLY SPONSORED RESEARCH OR DEVELOPMENT

Not Applicable.

### BACKGROUND OF THE INVENTION

The present invention relates generally to protective coatings, systems and methods of their application to a substrate. The invention particularly relates to roofing protection.

Various types of protective coatings and method of application are discussed in the prior art. At least one reference, U.S. Pat. No. 4,421,581, describes a woven fabric membrane disposed between two silicone rubber layers. This reference describes a dual thickness of silicon rubber situated on either side of a woven rubber impregnated fabric. The installation is time consuming and complex, however, because it requires the application of a first layer of pre-cured silicone solution using a sprayer, brush blade, or doctor blade, onto the roof substrate, placement of a woven fabric on top of the pre-cured silicone rubber solution before the latter cures, and applying a second layer of silicone solution on top of the fabric layer. The silicone rubber solution is then allowed to cure. The separate application of three layers onto a roof is time consuming. In addition, it is complex because the fabric layer must be applied before the first silicone rubber cures. Further, the roofing system must cure before it is completely functional and thus the roofing system and the structure underneath presumably must be protected from inclement weather until the roofing system is fully functional. There is a need for protective coverings particularly for roofs which are simple and quick to install, and which provide offer protection from environmental elements immediately upon application to the substrate, and which are resistant to oxidation and ultraviolet degradation from sunlight and ozone.

### BRIEF SUMMARY OF THE INVENTION

The invention features protective coatings and systems for a substrate and methods for their application. In one aspect, the invention features a pre-fabricated membrane which includes a support layer interposed between a first layer and a second layer. At least one of the first and the second layers includes a silicon component. At least the second layer has a resistance to water, oxidation, and ultraviolet radiation degradation.

In one embodiment, the membrane is adapted for applying to a substrate including a roof or section thereof. In another embodiment, the membrane includes one or more substantially planar sections for applying to a substrate. In yet another embodiment, the membrane is adapted for rolling onto the substrate. In still another embodiment, the membrane includes an adhesive on an outer surface of the first layer adapted for providing adhesion of the membrane to the substrate.

In one embodiment, the support layer includes a mesh. In another embodiment, the support layer can include a material selected from the group consisting of a cloth fabric, a metal, a synthetic polymer and a plastic.

In a preferred embodiment, the membrane consists of one or more non-organic materials.

In one embodiment, the membrane can have a thickness in a range of between greater than 0.2 mm and less than 6.1 mm. In other embodiments, the membrane can have a uniform or a variable thickness.

In one embodiment, the membrane can have a tensile strength of between more than 4 mPa and less than 90 mPa.

In another aspect, the invention features a method of forming a protective coating over a substrate. The method includes providing a pre-fabricated membrane; and applying the membrane to the substrate. The membrane includes a support layer interposed between a first and a second layer. At least one of the first and the second layers can include a silicon component. At least the second layer has a resistance to water, oxidation and ultraviolet radiation degradation.

In one embodiment, the substrate is a roof. In another embodiment, the step of applying the membrane to the substrate is conducted in an open air atmosphere where the membrane is possibly exposed to sun and water immediately upon application. In another embodiment, the application step includes rolling the membrane onto the substrate.

In one embodiment, the method includes providing a first layer including an adhesive layer on an outside surface of the first layer. In another embodiment, the method includes applying an adhesive layer directly to the substrate prior to applying the membrane to the substrate, wherein at least a portion of the membrane is disposed on at least a portion or the adhesive layer.

In one embodiment, the support layer includes a mesh. In another embodiment, the support layer includes a material selected from the group consisting of a cloth fabric, a metal, a synthetic polymer and a plastic.

In one embodiment, the membrane consists of one or more nonorganic materials. In another embodiment, the membrane has a thickness in a range of between greater than 0.2 mm and less than 6.1 mm, wherein the thickness is uniform or variable. In a further embodiment, the membrane has a tensile strength of between more than 4 mPa and less than 90 mPa.

In another aspect, the invention features a protective roofing system. The roofing system includes a pre-fabricated membrane including a support layer interposed between a first layer and a second layer. At least one of the first and the second layers includes a silicon component. At least the second layer has a resistance to water, oxidation, and ultraviolet degradation

### BRIEF DESCRIPTION OF THE SEVERAL VIEWS OF THE DRAWINGS

FIG. 1 is a vertical cross-sectional view of the protective covering applied to a substrate, according to an embodiment of the invention;

FIG. 2A shows the protective covering including a sheet, according to an embodiment of the invention; and

FIG. 2B shows the protective covering including a roll, according to an embodiment of the invention.

### DETAILED DESCRIPTION OF THE INVENTION

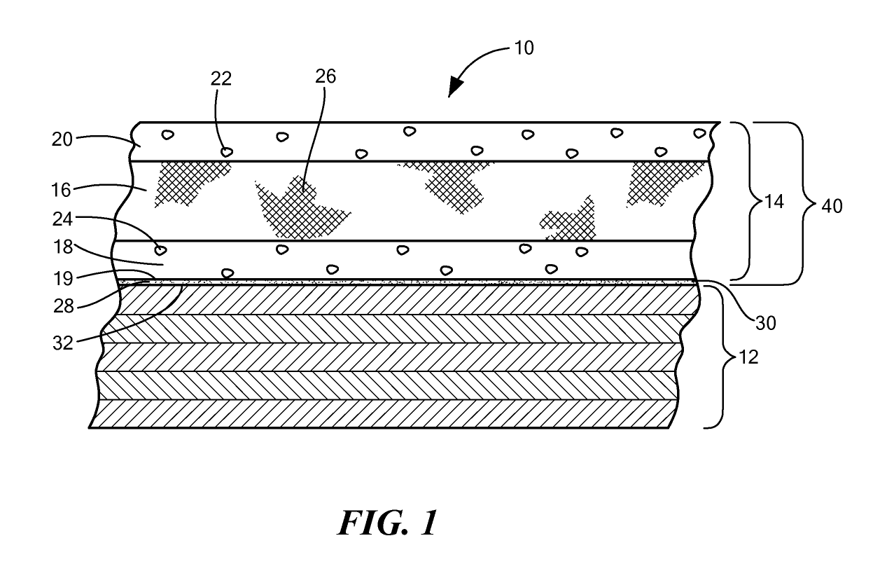

In one aspect, the invention provides a protective covering 10 for substrate 12, as shown in FIG. 1. The protective covering 10 includes a pre-fabricated membrane 14 which has a support layer 16 interposed between a first layer 18 and a second layer 20. At least one and preferable both of the first 18 and second 20 layers includes respectively a silicon component 22 and 24.

At least one and preferably of both of the first 18 and second 20 layers has a water resistance. For the purposes of this application, the terms “water resistant” or “water resistance” as defined as “having an ability to withstand penetration of water inside the layer to a pre-determined degree; the terms “water repellant” or “water repellence” is defined as “hydrophobic or having the ability to repel water to a predetermined degree”; and the term “waterproof” is defined as “impermeable to water to a pre-determined degree”. For purposes of this application, the term water resistant or resistance will be considered to encompass the terms water repellent or water repellence and waterproof. Water resistance can be evaluated by the method: ASTM D3393-91 (2014) and/or by other methods known to those of ordinary skill in the art.

In addition, at least the second layer 20 has a resistance to oxidation degradation. Oxidation resistance can be evaluated by the method: ASTM D572-04 (2010) and/or by other methods known to those of ordinary skill in the art.

Further, at least the second layer 20 has a resistance to ultraviolet radiation degradation. Resistance to ultraviolet degradation can be evaluated by the method: ASTM D 1148-B and/or by other methods known to those of ordinary skill in the art.

At least the second layer 20 also has a resistance to ozone degradation. Resistance to ozone degradation can be measured by the ASTM D 1171 method B and/or by other methods known to those of ordinary skill in the art.

In addition, at least the second layer 20 and preferably both the first 18 and second 20 layers, and even more preferably, the entire membrane 14, can have a resistance to low temperature brittleness. Resistance to low temperature brittleness can be evaluated by method: ASTM 2137 method A 9.3.2. at 3 minutes and −40° C., and/or by other methods known to those of ordinary skill in the art.

The membrane 14 can be particularly adapted for covering an open-air substrate, such as, for example, a roof or a partial section thereof. Thus, in one aspect, the invention also features a protective roofing system 40 including the pre-fabricated membrane 14 described herein. Preferably, the second layer 20, and more preferably, the first 18 and second 20 layers, and most preferably, the entire membrane 14 includes or consists of one or more non-organic materials which are resistant to water, oxidation degradation, and ultraviolet radiation degradation. Such materials slow or reduce ageing, rotting, and prolong the life of the membrane product. The membrane 14 is fully cured and formed prior to application to the substrate 12. Thus, in a roof application, the pre-fabricated membrane 14 can be applied without lengthy or complicated installation involving application of a first layer, a waiting time for membrane curing or other processing, applying a second layer, and possibly further curing or other processing time, and so forth. The membrane can include an adhesive 28 or an additional adhesive layer 30 affixed to an outer surface of the first layer 18 for affixing or adhering the first layer 18 to the surface 32 of the substrate 12.

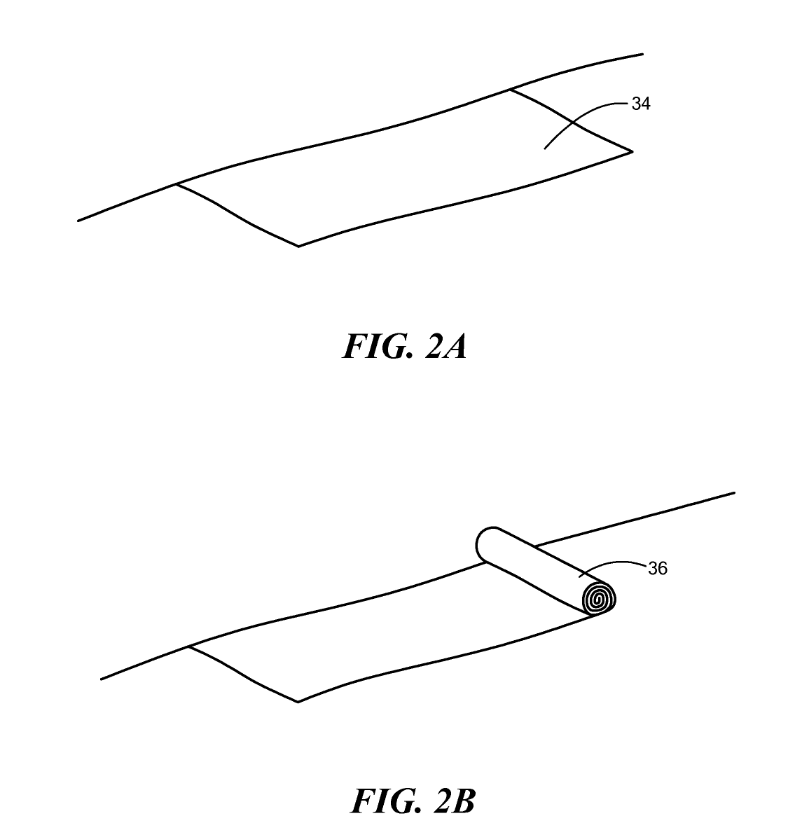

Depending upon the application, the membrane 14 can be substantially rigid or substantially flexible. The membrane 14 can be provided in one or more sections, and in substantially planar 34 sheets, as shown in FIG. 2A, or rolls 36, as shown in FIG. 2B, for a relatively simple and speedy installation. The membrane can be adapted for different orientations such as, for example, substantially vertical orientations, substantially horizontal orientations, and/or orientations which lie somewhere between substantially vertical and substantially horizontal orientations.

The support layer 16 of the membrane 14 can include a mesh 26. The mesh 26 can include one or more materials, such as, for example, a cloth fabric, a metal, a synthetic polymer or polymers, a plastic or plastics, or different combinations thereof. The silicon component 18 of the first layer 18 and/or the silicon component 22 of the second layer 20 can be impregnated into open holes or pores of the network of the mesh and can extend a water resistant quality to the support layer 16 in addition to the first 18 and/or second 20 layer.

The membrane 14 can have a uniform or a variable thickness depending upon the application. For example, it may be desirable to have a thicker membrane in an area where a steeper or generally more vertical portion of the substrate meets a less steep or generally more horizontal portion of the substrate and the propensity for water collection is greater. Generally, the membrane or a portion of the membrane can have a thickness in a range of between 0.2 mm and 6.1 mm, preferably between 1.0 and 5.0 mm, more preferably 1.5 and 4.0 mm, and most preferably 2.0 and 3.0 mm.

The first 18 and second 20 layers provide a tensile strength to the support layer 16. The backbone or spine of the membrane does not need to provide the entire sheer resistance for the membrane because of the layer combination. The membrane 14 is characterized by having a tensile strength of between greater than 4 MPa and less than 90 MPa, and preferably between greater than 10 MPa and less than 90 MPa, and more preferably between greater than 20 MPa and less than 90 MPa, and most preferably between greater than 28 MPa and less than 90 MPa.

In another aspect, the invention provides a method of forming or applying a protective covering 10 to a substrate 12. The method includes providing the pre-fabricated membrane 14 of the invention, as described above, and applying the membrane 14 to a substrate 14. In one embodiment, the substrate 12 is a roof or a partial section of a roof. The method includes curing the membrane or otherwise manufacturing the membrane 14 prior to applying the membrane to the substrate. Thus, the membrane which is provided to the installation site is pre-fabricated, fully cured, as necessary, and fully formed. Installation is therefore simpler and faster as compared to installations which require layering of discrete separate layers and on-site curing or other types of processing during installation before the protective covering can be fully functional. Further, the membrane can be applied in an open air environment where the membrane is possibly immediately exposed to environmental elements such as air and water.

The membrane 14 can be provided in substantially planar sheets 34, as shown in FIG. 2A, or rolls 36, as shown in FIG. 2B, and can be applied in one or more sections to a substrate or part of a substrate 12 by laying or rolling the membrane or sections thereof onto the substrate 12. The membrane 14 can be applied in substantially vertical orientations, substantially horizontal orientations, and/or orientations which lie somewhere between substantially vertical and substantially horizontal orientations. The method can include applying an adhesive 28 or an adhesive layer 30 to the substrate 12, to an outer surface 19 of the first 18 layer, or to both, in order to adhere the membrane to the substrate. The adhesive 28 or adhesive layer 30 can be applied using a brush, spray or other device or process known to those of ordinary skill in the art for applying adhesive to a surface.

The foregoing examples and detailed description are not to be deemed limiting of the invention which is defined by the following claims. The invention is understood to encompass such obvious modifications thereof as would be apparent to those of ordinary skill in the art.

What is claimed is:

1. A protective coating for a substrate comprising:
a pre-fabricated membrane including a support layer interposed between a first layer and a second layer;
wherein at least one of the first and the second layers includes a silicon component;
wherein at least the second layer has a water resistance, and an oxidation resistance; and an ultraviolet degradation resistance.

2. The protective covering of claim 1, wherein the membrane is adapted for applying to the substrate including a roof or section thereof.

3. The protective covering of claim 1, wherein the membrane includes one or more substantially planar sections for applying to the substrate.

4. The protective covering of claim 1, wherein the membrane is adapted for rolling onto the substrate.

5. The protective covering of claim 1 further comprising an adhesive on an outer surface of the first layer adapted for providing adhesion of the membrane to the substrate.

6. The protective covering of claim 1, wherein the support layer includes a mesh.

7. The protective covering of claim 1, wherein the support layer includes a material selected from the group consisting of a cloth fabric, a metal, a synthetic polymer and a plastic.

8. The protective covering of claim 1, wherein the membrane consists of one or more non-organic materials.

9. The protective covering of claim 1,
wherein the membrane has a thickness in a range of between greater than 0.2 mm and less than 6.1 mm; and
wherein the thickness is uniform or variable.

10. The protective covering of claim 1, wherein the membrane has a tensile strength of between more than 4 mPa and less than 90 mPa.

11. A method of forming a protective coating over a substrate comprising:
providing a pre-fabricated membrane; and
applying the membrane to a substrate;
wherein the membrane comprises a support layer interposed between a first and a second layer,
wherein at least one of the first and the second layers include a silicon component;
wherein at least the second layer has a water resistance, an oxidation resistance, and an ultraviolet radiation degradation resistance.

12. The method of claim 11, wherein the substrate is a roof.

13. The method of claim 11, wherein the step of applying the membrane to the substrate is conducted in an open air atmosphere where the membrane is possibly exposed to sun and water immediately upon application.

14. The method of claim 11, wherein the applying step comprises rolling the membrane onto the substrate.

15. The method of claim 11 further comprising
applying an adhesive to the substrate prior to applying the membrane to the substrate;
wherein at least a portion of the membrane is disposed on at least a portion of the adhesive layer.

16. The method of claim 11, wherein the support layer includes a mesh.

17. The method of claim 11, wherein the support layer includes a material selected from the group consisting of a cloth fabric, a metal, a synthetic polymer and a plastic.

18. The method of claim 11, wherein the membrane consists of one or more nonorganic materials.

19. The method of claim 11, wherein the membrane has a thickness in a range of between greater than 0.2 mm and less than 6.1 mm; and wherein the thickness is uniform or variable.

20. The method of claim 11, wherein the membrane has a tensile strength of between more than 4 m Pa and less than 90 mPa.

21. A protective roofing system comprising
a pre-fabricated membrane including a support layer interposed between a first layer and a second layer;
wherein at least one of the first and the second layers includes a silicon component;
wherein at least the second layer has a water resistance, an oxidation resistance; and an ultraviolet radiation degradation resistance;
wherein the support layer includes a mesh selected from the group consisting of a cloth fabric, a metal, a synthetic polymer, and a plastic;
wherein the membrane has a thickness in a range of between greater than 0.2 mm and less than 6.1 mm, and the thickness is uniform or variable; and
wherein the membrane has a tensile strength of between more than 4 mPa and less than 90 mPa.
